(19) United States
(12) Patent Application Publication
(10) Pub. No.: US 2025/0048340 A1
(43) Pub. Date: Feb. 6, 2025

(54) METHOD AND APPARATUS FOR PERFORMING MESSAGE COLLISION AVOIDANCE IN A COMMUNICATIONS NETWORK

(71) Applicant: Trilliant Networks Inc., Cary, NC (US)

(72) Inventors: Jean-Philippe Joseph Denis Comtois, Granby (CA); Michel Veillette, Waterloo (CA)

(21) Appl. No.: 18/228,384

(22) Filed: Jul. 31, 2023

(51) Int. Cl. H04W 72/0446; H04W 72/231; H04W 72/30; H04W 74/04

(52) U.S. Cl. CPC H04W 72/0446; H04W 72/231; H04W 72/30; H04W 74/04

(57) ABSTRACT

A method and apparatus for performing collision avoidance in a time slotted, channel hopping (TSCH) communications network. A media access control (MAC) layer controls message addressing and channel access, wherein the MAC layer performs at least one of the following:
(1) allocating specific timeslots for messages being communicated downstream from a border router to a destination node;
(2) selecting a transmission channel for messages on a pseudo-random basis using a TSCH absolute slot number and a destination node identification; or
(3) allocating specific timeslots to broadcast messages.

### BACKGROUND

### Field

Embodiments of the present invention generally relate to communication networks and, in particular, to a method and apparatus for performing message collision avoidance in a communications network.

### Description of the Related Art

Communications networks, in particular, mesh radio networks, consist of network nodes (e.g., data transceivers) that connect directly, dynamically, and non-hierarchically to other nodes and cooperate with one another to efficiently route data through the network. Some mesh network nodes can dynamically serve as a router for every other node. In that way, even in the event of a failure of some nodes, the remaining nodes may continue to communicate with each other and, if necessary, serve as downlinks/uplinks for other nodes. The nodes are generally implemented using half-duplex radio which can transmit or receive but not both operations simultaneously.

Currently, the Internet Engineering Task Force (IETF) 6TiSCH Operation sublayer (6TOP) protocol allows for allocation of resources in a network; however, IETF 6TOP uses a three or four-way handshake, which increases the traffic within the network. Furthermore, network resources need to be allocated in advance to allow their use by the routed IP traffic. This static allocation of resources is inefficient in networks for which traffic flow and routing paths are constantly changing.

Networks, such as mesh radio networks, consist of nodes (i.e., devices that perform data transceiving) that connect directly, dynamically, and non-hierarchically to other nodes and cooperate with one another to efficiently route data through the network. Nodes implementing the TSCH Medium Access Control (MAC) layer are periodically switching channels (i.e., hopping).

Because of their dynamic and non-hierarchical nature, mesh networks are prone to message collisions and message traffic congestion. When collisions occur, the nodes must resend the message which adds to network traffic and additional message congestion. Message collisions occur under a number of scenarios. For example, when a first node transmits a message at the same time (e.g., in the same timeslot) that a neighboring second node is transmitting a message to the first node, i.e., in the reverse direction, the first and second node will be unable to receive either message. In a second collision scenario, two neighboring nodes transmit to a third node at the same time resulting in the third node being unable to receive the transmission from either of the other two nodes. In a third scenario, two independent pairs of nodes communicating on two different transmission links are located near enough to each other to cause RF interference to an extent that the links interfere with one another causing data packets to be dropped. In a fourth collision scenario, a node initiates a broadcast message to all of its neighbors at the same time some of the neighbors are attempting to communicate with other nodes such that the broadcast message interferes with the neighbor nodes' communications. All of these collision scenarios result in transmission retries, increased communications latency and may lead to packet loss.

The common solution to the collision problem in a Time Slotted Channel Hopping (TSCH) network is the allocation of dedicated timeslot(s) to transmit on specific links, in a specific direction. This solution is complex to implement, to maintain, and not well adapted to large networks with sporadic transmissions. For example, a node with 50 neighbors must allocate 100 dedicated timeslots to avoid collisions to and from these neighbors. In this case, each neighbor has a transmission opportunity only at each 100 timeslots. This approach increases the latency and reduces the bandwidth available for each link.

Therefore, there is a need for a method and apparatus for performing message collision avoidance in a communications network.

### SUMMARY

A method and apparatus for performing message collision avoidance in a communications network is provided substantially as shown in and/or described in connection with at least one of the figures, as set forth more completely in the claims.

Various features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a diagram of an exemplary network implementing collision avoidance techniques according to one or more embodiments of the invention;

FIG. 2 depicts a block diagram of an exemplary network node for use within a routed network implementing collision avoidance techniques according to one or more embodiments of the invention;

FIGS. 3A-3E depict possible slot frame and timeslots in a time-slotted channel hopping (TSCH) network, according to one or more embodiments of the invention; and

FIG. 4 depicts a flow diagram of operation of an extended MAC layer in accordance with at least one embodiment of the invention.

### DETAILED DESCRIPTION

Embodiments of the present invention comprise a method and apparatus for performing collision avoidance in a communications network.

Various embodiments of a method and apparatus for performing collision avoidance in a network are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on digital signals stored within a memory of a specific apparatus or special purpose computing device or platform. In the context of this specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device can manipulate or transforming signals, typically represented as physical electronic or magnetic quantities within memories, registers, or other information storage devices, transmission devices, or display devices of the special purpose computer or similar special purpose electronic computing device. As used herein, the term device may include a mesh device, a routed device, or any device or node in a network.

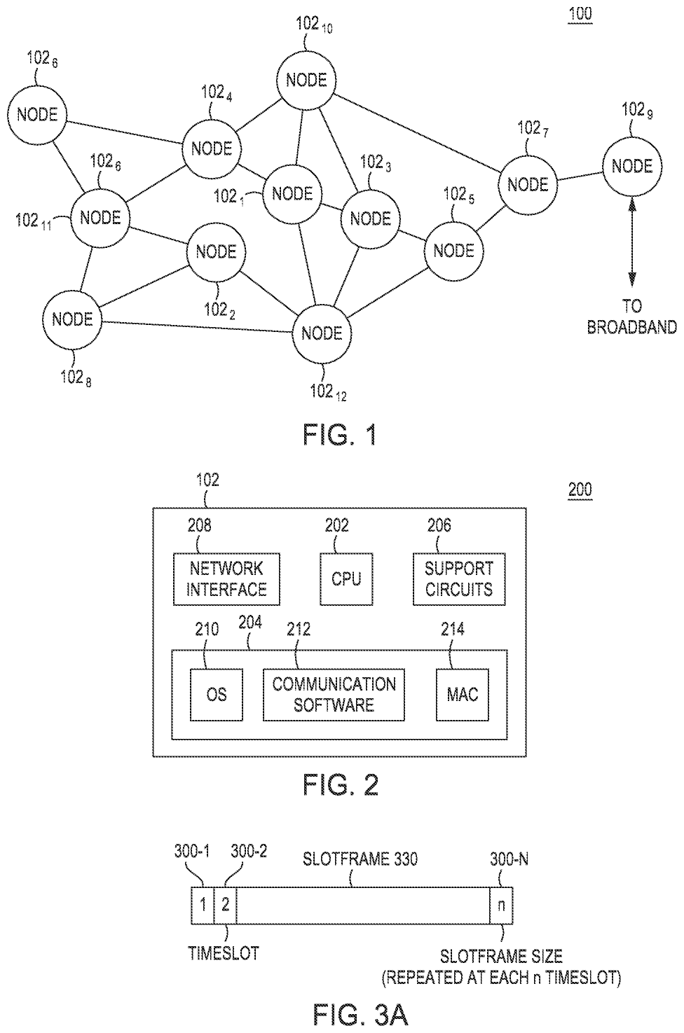

FIG. 1 is a graphical depiction of a network 100 comprising connected nodes 102-1, 102-2, 102-3 . . . 102-12 (collectively referred to as nodes 102), according to one or more embodiments of the invention. The nodes 102 are interconnected to each other such that, for most nodes, multiple paths exist between each node 102. An exemplary network that may utilize and benefit from the present invention is a mesh network. Those skilled in the art can realize from the following disclosure that other network topologies, both wired and wireless, may find benefit by using embodiments of the present invention.

At least one node is a border node (e.g., node 102-9) that typically connects to a broadband internet connection. Downstream message traffic flows from the border node through the other nodes to reach destination nodes. Upstream message traffic flows from the destination node(s) to the at least one border node. In one embodiment, the nodes communicate using a time slotted, channel hopping (TSCH) protocol such as defined in the IEEE 801.15.4 standard.

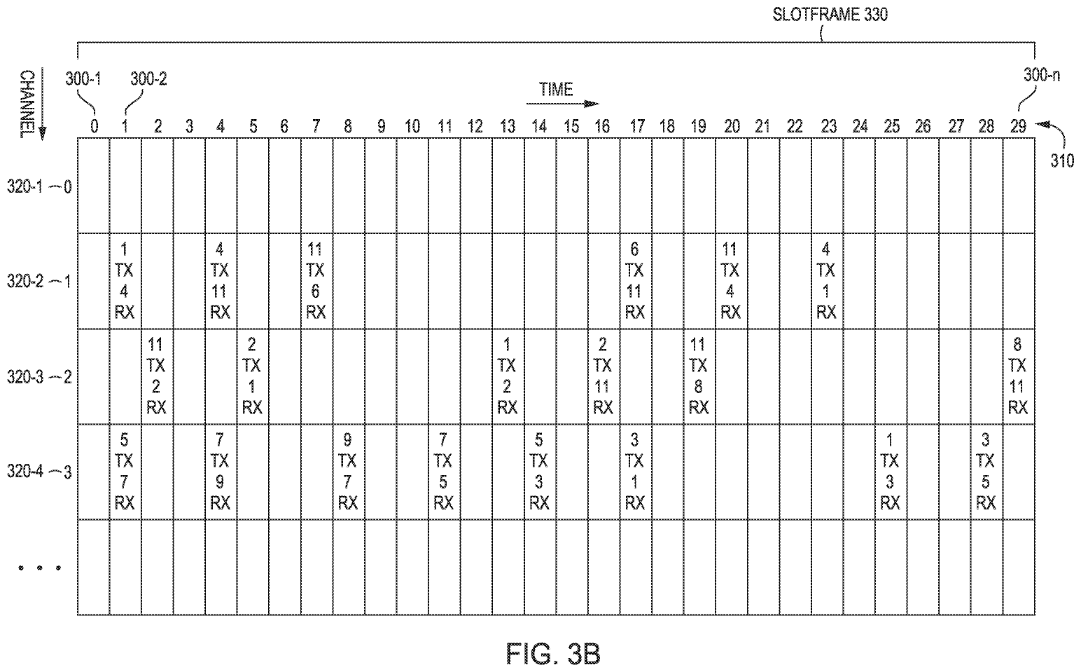

FIG. 2 is a block diagram 200 of an exemplary node 102 in accordance with one or more embodiments of the invention. The node 102 may be one or more individual Internet of Things (IoT) devices, such as meters, sensors, streetlights, and the like that may benefit from connection to a computer or communications network.

The node 102 comprises a central processing unit (CPU) 202, support circuits 206, memory 204 and a network interface 208. The CPU 202 may comprise one or more readily available microprocessors or microcontrollers. The support circuits 206 are well known circuits that are used to support the operation of the CPU and may comprise one or more of cache, power supplies, input/output circuits, network interface cards, clock circuits, and the like. Memory 204 may comprise random access memory, read only memory, removable disk memory, flash memory, optical memory or various combinations of these types of memory. The memory 204 is sometimes referred to as main memory and may, in part, be used as cache memory or buffer memory. The memory 204 stores various forms of software and files, such as, an operating system (OS) 210, communication software 212 and software instructions for a medium access control (MAC) layer 214. The operating system 210 may be one of several well-known operating systems or real time operating systems such as FreeRTOS, TheadX, LINUX, WINDOWS, and the like.

The network interface 208 connects the node 102 to the network 100. The network interface 208 may facilitate a wired or wireless connection to other nodes. In some embodiments, for example, when node 102 is a border router, node 102 may have multiple interfaces 208 for routing within the network 100 as well as to connect to another network.

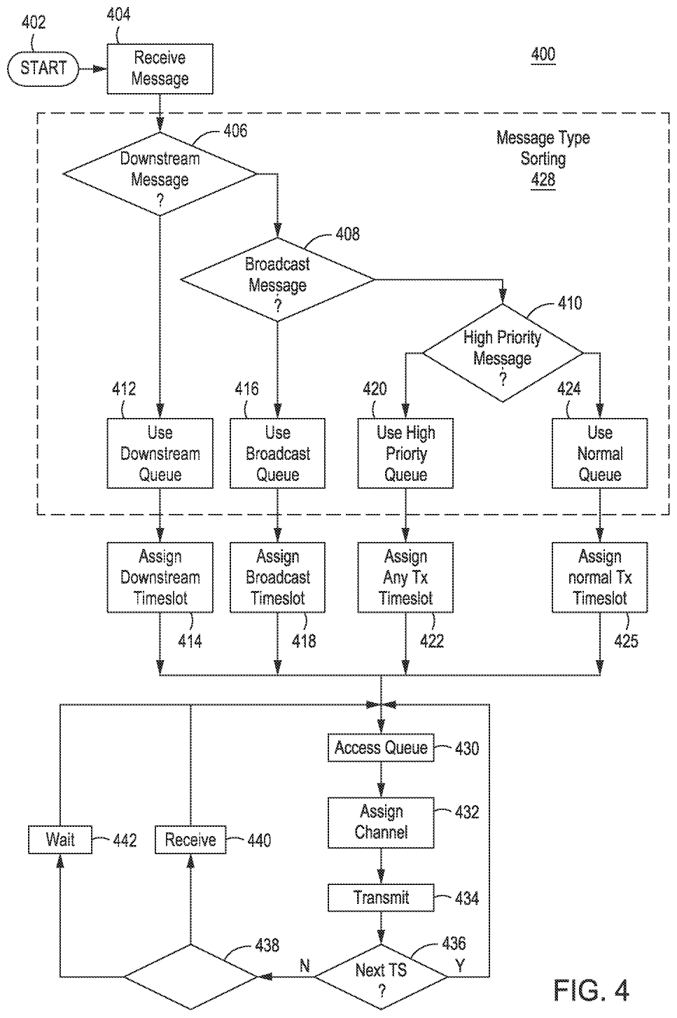

Each node 102 receives and transmits messages using a TSCH protocol such that messages are arranged into frames and communicated in selected timeslots and selected radio channels. The addressing of messages, time slot selection and channel access control are controlled by the MAC layer 214 as executed by the CPU 202. The MAC layer 214 resides in the software stack between the application layer (the communication software 212) and the physical layer, i.e., the hardware devices used to support communications (e.g., the network interface 208). Details of operation of the MAC layer 214 are described with respect to FIG. 4 below.

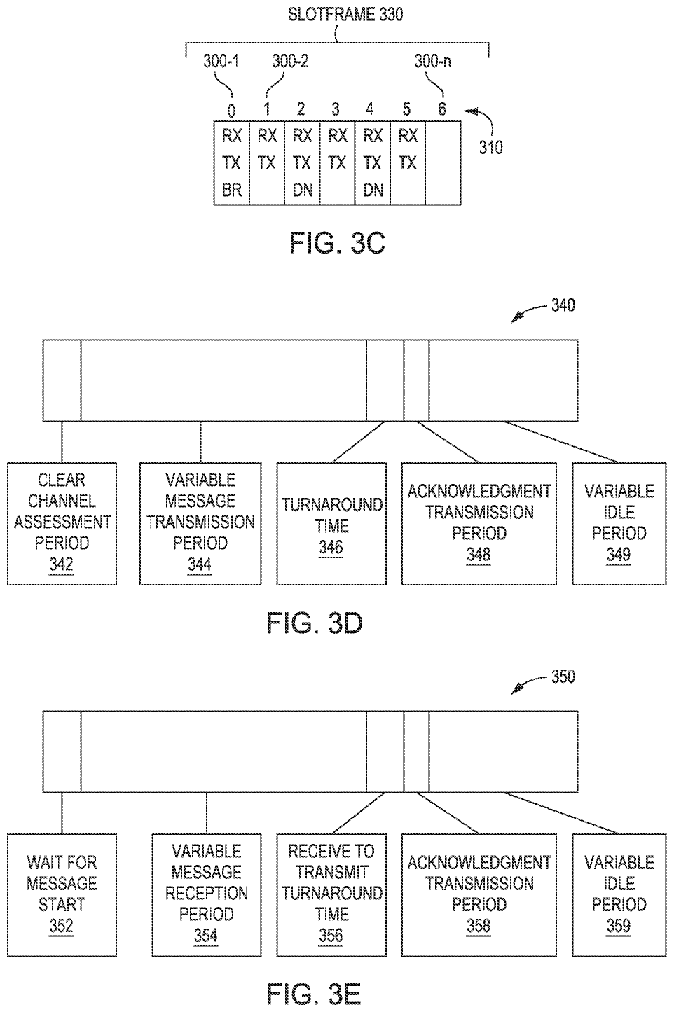

FIGS. 3A and 3B depict a possible slotframe and timeslots in a time-slotted channel hopping (TSCH) network, according to one or more embodiments of the invention. In FIG. 3A, time is divided into timeslots 300-1, 300-2, . . . 300-n (collectively referred to as timeslot 300). Each timeslot 300 is long enough for a physical data unit (PDU) of maximum size to be sent from a first node to second node and an acknowledgement to be received back at the transmitting node. Timeslots 300 are grouped into slotframe 330. Multiple slotframes may be defined within a node to create a TSCH schedule. A TSCH schedule instructs each node what to do in each timeslot 300: transmit and/or receive or stay idle.

FIG. 3B depicts an exemplary collective schedule. The schedule indicates, for each scheduled (transmit or receive) timeslot, a channel offset 320-1, 320-2, 320-n (collectively referred to as channel offset 320), and the address of the neighbor node with which to communicate. Once a node obtains its schedule, the node executes the schedule. For each transmit timeslot, the node checks whether there is a message in the outgoing buffer (e.g., a plurality of queues as described in more detail below) that matches the neighbor written in the schedule information for that timeslot. For each receive timeslot, the node listens for possible incoming messages.

FIG. 3C depicts an exemplary of slotframe incorporating embodiments of the present invention. In this example, timeslot 0 is reserved for broadcast messages. Timeslots 2 and 4 are reserved for downstream messages, the remaining timeslot can be used by upstream messages or peer to peer communications. High priority traffic can be transferred by any timeslot with the TX flag enabled, timeslots 0 to 5 in this case. Dedicated timeslots configured using a slotframe as shown in FIG. 3B can be used in conjunction with the timeslot as shown in FIG. 3C. Dedicated timeslots may be set to unused timeslots in slotframe FIG. 3C or the FIG. 3B slotframe may be configured with a higher priority.

The schedule also comprises a TSCH absolute slot number (ASN) which is a sequential count of timeslots shown at 310. The ASN increments at each timeslot and is shared amongst all nodes. In some embodiments, the ASN may be used to pseudorandomly select a transmission channel to use for a transmission as described in detail below.

FIGS. 3D and 3E depict examples of a scheduled transmit timeslot 340 and a scheduled receive timeslot 350.

The scheduled timeslot 350 start off with a Clear Channel Assessment (CCA) period 342. CCA determines if the transmission channel is already in use or not. There is no transmission if that channel is occupied. If the network does not use a CCA, this period is not present. In the case that the CCA determines that the channel is occupied, then the node treats the remainder of the timeslot as idle.

If the channel is free and the node has a message to transmit, it does so in the variable message transmission period 344. The size of the period varies with the size of the message to be transmitted.

After transmitting a message, the node must switch from transmit mode to receive mode and wait for an acknowledgement in period 346.

The acknowledgement of the message from the receiver is received in the acknowledgement transmission period 348.

After the acknowledgment is received, the transmitting node is finished with the timeslot. The timeslot period is usually designed to accommodate a CCA 342, maximum sized packet 344, a transmit to receive turnaround time 346 and a maximum sized acknowledgement 348.

The scheduled receive timeslot 350 is designed to be compatible with the scheduled transmit timeslot 340. The wait period for message start 352 is set to be longer than the sum of the CCA period 342, inter-node clock inaccuracies and any inter-node time-of-flight propagation time. The receiving node should detect a scheduled transmission within the wait period 352. If a start of message is detected, the receiving node will examine it and determine if it accepts the message. The complete message is received in the variable period 354. After the message is received and accepted the node must switch from reception to transmission 356. The acknowledgement is then transmitted in period 358.

When a collision or interference occur as described above, the receiving node will not send an acknowledgement. The lack of an acknowledgement will cause the transmitting node to retransmit the message in its next scheduled timeslot for communication to that receiving node. Such retransmissions cause inefficiency and unnecessary traffic on the network. Thus, embodiments of the present invention strive to minimize collisions.

Embodiments of the invention form an extension of the traditional MAC layer operation such that various collision avoidance operations are built into the MAC layer functionality. The extended functionally is implemented upon configuration of the MAC layer when the network is initialized. As each node enters the network, the node MAC layer is initialized with the extended MAC layer functions of embodiments of the invention. In some embodiments, the extended MAC layer includes at least one function that performs one or more of the following:
1) Reserve specific timeslots for transmitting only downstream messages;
2) Reserve specific timeslots for transmitting only broadcast messages; and
3) Channel selection performed using a pseudo-random channel selection based upon the destination node identification and the absolute slot number (ASN)
   To facilitate transmission of messages in reserved timeslots, the extended MAC layer also segregates messages into specific message type queues.

In one embodiment, the extended MAC layer operates to prepare each message for transmission, then sorts the message into specific queues by message type. The queues are accessed to extract a message from a particular queue for transmission in an appropriate timeslot for that message type using a particular transmission radio channel. In one embodiment, the radio channel may be pseudorandomly selected using a selection function based upon the destination node ID (e.g., MAC address) and the ASN.

FIG. 4 depicts a flow diagram of a method 400 of operation of an extended MAC layer to perform collision avoidance in accordance with at least one embodiment of the invention. The method 400 begins at 402 and proceeds to 404 where the method receives one or more messages for transmission. The method 400 sorts messages as they are made available by the communications layer above the extended MAC layer. At 406, 408 and 410, the method 400 tests the message type as to whether the message is a downstream message, a broadcast message or a high priority message. If the message is not one of these three types, then the method 400 deems the message a normal message. At 412, 416, 420 and 424, each message type is placed in an appropriate queue. The combination of functions performed at 406, 408, 410, 412, 416, 420, and 424 collectively perform message type sorting 428.

In one embodiment, to determine if the message is a downstream message, the border node (access point) tags downstream packets using a flag of the traffic class field within the IPV6 data packet header. Consequently, at 412, the downstream message is segregated into a downstream message queue to await transmission.

In other embodiments, the communications software layer above the MAC layer, may provide an indication of the message type to the MAC layer such that the MAC layer does not need to inspect the message.

At 414, the downstream message is assigned a downstream message timeslot. For every node, the extended MAC layer ensures that downstream messages are transmitted in a specifically assigned downstream message timeslot. In this manner, the extended MAC layer ensures that all downstream messages in all nodes are sent in the designated timeslot and that timeslot is not used for any other messages (e.g., upstream messages). The result is no collisions can occur for downstream messages because no upstream messages will ever be sent in that timeslot. Thus, upstream and downstream messages will never collide at any node.

At 418, a broadcast message is assigned to a specific broadcast timeslot. Broadcast timeslots are configured using a common channel offset to enable reception of the transmission by neighboring nodes. Consequently, all broadcasts occur in a defined timeslot on a common channel.

At 422, a high priority message is assigned to the next transmission timeslot (i.e., a timeslot with the TX Link option set). This timeslot can be a downstream, a broadcast or normal transmission timeslot. Consequently, high priority messages are always transmitted ahead of any other messages present in the other queues.

As each timeslot becomes available to be filled with a message, the method 400 performs 430, 432, 434 and 436 to fill the next timeslot with a message if a message is available in the assigned queue for the destination node associated with the timeslot. At 430, a message (for example a downstream message) will be accessed from the downstream message queue, then, at 432, will be assigned a transmission channel and sent in the downstream timeslot.

In an embodiment of the invention, the transmission channel selection may also be a process that is performed by the extended MAC layer. At 426, the method 400 pseudorandomly selects a channel based on the TSCH absolute slot number (ASN) and the target destination node address for the message. In one embodiment, the function used for selecting the channel is:

channel=F[H(dMACid concat ASN)mod NbChannels]
where dMACid denotes the MAC ID of the destination node, ASN is a sequential count of timeslots, NbChannels is the number of physical channels, and mod is the modulo operator. H( ) is a hash function used to generate a pseudorandomly distributed output value. F[ ] is a bijective function mapping an integer comprised between 0 and NbChannels into a physical channel.

Once the transmission timeslot and channel frequency are determined, at 434, the method 400 transmits the message using that determined timeslot-frequency pair. The destination receiver will await the transmission in that timeslot and on that channel. Once the message is received, the receiver sends an acknowledgement to the transmitting node before the end of the timeslot period. Note the receiver may use the same equation above for selecting a frequency, but rather than a destination node MAC address, the receiver node is using its own MAC address (which, of course, is the same as the destination MAC address).

At 436, the method 400 queries whether the next timeslot should be filled with a message. If the query is answered affirmatively, the method 400 returns to 430 along path 438 to access the queue associated with the message type to be sent in the next timeslot and prepare the next message for transmission. If the query is negatively answered, the method 400 decides at query 438, based on the slotframe(s) configuration, to perform a receive at 440 or wait for the next timeslot at 442.

In an alternative embodiment, the upper layer communication API may provide the message type to the MAC layer along with the message such that the extended MAC layer sorts the message into the appropriate queue, e.g., a direct message sorting at 430 to function as the queries 406, 408, and 410 described above). As such, the extended MAC layer does not have to perform the queries described above or inspect each message to derive the message type. As the timeslots progress, the extended MAC layer accesses the message in a queue(s) having a message type assigned to the next timeslot within a slotframe (e.g., broadcast is timeslot 0, normal in timeslot 1, downstream in timeslot 2, etc.) The types of messages described herein are exemplary and do not represent an exhaustive list of message types. The extended MAC layer may also pseudorandomly assign a transmission channel as described above using the destination node identification and the ASN. In other embodiments, the channel may be selected in a conventional manner used by a TSCH MAC layer. In other embodiments, the extended MAC layer may not perform message type sorting and may only perform pseudorandom channel selection. In other alternative embodiments, the extended MAC layer may only segregate a specific type of message (e.g., only downstream or only broadcast) into a separate queue. In other embodiments, combinations of sorting may be performed (e.g., downstream and broadcast messages are sorted into queues, but other message types are not).

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g., A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. A method of performing collision avoidance in a time slotted, channel hopping (TSCH) communications network comprising:
controlling message addressing and channel access utilizing a media access control (MAC) layer, wherein the MAC layer performs at least one of the following:
(1) allocating specific timeslots for messages being communicated downstream from a border router to a destination node;
(2) selecting a transmission channel for messages on a pseudo-random basis using a TSCH absolute slot number and a destination node identification; or
(3) allocating specific timeslots to broadcast messages.

2. The method of claim 1, further comprising identifying a downstream message type to enable allocating timeslots to downstream messages.

3. The method of claim 1, further comprising identifying a broadcast message type to enable allocating specific timeslots to broadcast messages.

4. The method of claim 1, further comprising providing a specific channel offset to configure a timeslot to select a transmission channel on a pseudo-random basis.

5. The method of claim 1, wherein the message type queues used for segregating messages comprise a broadcast message type queue, a downstream message type queue, a high-priority message type queue and a normal message type queue.

6. The method of claim 1, wherein selecting a transmission channel further comprising using the equation:
channel=F[H(dMACid concat ASN)mod NbChannels]
where dMACid denotes the MAC ID of the destination node, ASN is a sequential count of timeslots, NbChannels is a number of physical channels, mod is a modulo operator, H( ) is a hash function used to generate a pseudo randomly distributed output value and F[ ] is a bijective function mapping an integer comprised between 0 and NbChannels into a physical channel.

7. The method of claim 1, wherein the message destination identification is the MAC ID of the destination node.

8. Apparatus for performing collision avoidance in a time slotted, channel hopping (TSCH) communications network comprising at least one processor and at least one non-transient computer readable medium for storing instructions that, when executed by the at least one processor, causes the apparatus to perform operations comprising:
controlling message addressing and channel access utilizing a media access control (MAC) layer, wherein the MAC layer performs at least one of the following:
(1) allocating specific timeslots for messages being communicated downstream from a border router to a destination node;
(2) selecting a transmission channel for messages on a pseudo-random basis using a TSCH absolute slot number and a destination node identification; or
(3) allocating specific timeslots to broadcast messages.

9. The apparatus of claim 8, further comprising an operation of identifying a downstream message type to enable allocating timeslots to downstream messages.

10. The method of claim 8, further comprising an operation of identifying a broadcast message type to enable allocating specific timeslots to broadcast messages.

11. The method of claim 8, further comprising an operation of providing a specific channel offset to configure a timeslot to select a transmission channel on a pseudo-random basis.

12. The method of claim 8, wherein the message type queues used for segregating messages comprise a broadcast message type queue, a downstream message type queue, a high-priority message type queue and a normal message type queue.

13. The method of claim 8, wherein selecting a transmission channel further comprising an operation of using the equation:
channel=F[H(dMACid concat ASN)mod NbChannels]
where dMACid denotes the MAC ID of the destination node, ASN is a sequential count of timeslots, NbChannels is a number of physical channels, mod is a modulo operator, H( ) is a hash function used to generate a pseudo randomly distributed output value and F[ ] is a bijective function mapping an integer comprised between 0 and NbChannels into a physical channel.

14. The method of claim 8, wherein the message destination identification is the MAC ID of the destination node.

15. A non-transient computer readable medium for storing instructions for performing collision avoidance in a time slotted, channel hopping (TSCH) communications network, wherein at least one processor, when executing the instructions, creates a media access control layer to perform operations comprising at least one of the following:
(1) allocating specific timeslots for messages being communicated downstream from a border router to a destination node;
(2) selecting a transmission channel for messages on a pseudo-random basis using a TSCH absolute slot number and a destination node identification; or
(3) allocating specific timeslots to broadcast messages.

16. The apparatus of claim 15, further comprising an operation of identifying a downstream message type to enable allocating timeslots to downstream messages.

17. The method of claim 15, further comprising an operation of identifying a broadcast message type to enable allocating specific timeslots to broadcast messages.

18. The method of claim 15, further comprising an operation of providing a specific channel offset to configure a timeslot to select a transmission channel on a pseudo-random basis.

19. The method of claim 15, wherein the message type queues used for segregating messages comprise a broadcast message type queue, a downstream message type queue, a high-priority message type queue and a normal message type queue.

20. The method of claim 15, wherein selecting a transmission channel further comprising an operation of using the equation:
channel=F[H(dMACid concat ASN)mod NbChannels]
where dMACid denotes the MAC ID of the destination node, ASN is a sequential count of timeslots, NbChannels is a number of physical channels, mod is a modulo operator, H( ) is a hash function used to generate a pseudo randomly distributed output value and F[ ] is a bijective function mapping an integer comprised between 0 and NbChannels into a physical channel.

21. The method of claim 15, wherein the message destination identification is the MAC ID of the destination node.
